(19) United States
(12) Patent Application Publication
(10) Pub. No.: US 2010/0212697 A1
(43) Pub. Date: Aug. 26, 2010

(54) Controlling method of a dishwasher

(76) Inventors: Sang Heon Yoon, Seoul (KR); Young Hwan Park, Seoul (KR); Seong Ho Kim, Seoul (KR)

Correspondence Address: MCKENNA LONG & ALDRIDGE LLP, 1900 K STREET, NW, WASHINGTON, DC, 20006, US

(21) Appl. No.: 12/659,026

(22) Filed: Feb. 23, 2010

(30) Foreign Application Priority Data
Feb. 24, 2009 (KR) 10-2009-0015105

(51) Int. Cl. B08B 9/20

(52) U.S. Cl. 134/25.2

(57) ABSTRACT

A controlling method of a dishwasher to enhance washing efficiency and to reduce washing time, the controlling method of a dishwasher including a wash water supplying step and a steam supplying step where, for a predetermined amount of time, the wash water supplying step is simultaneously performed with the steam supplying step.

This application claims the benefit of Korean Patent Application No. 10-2009-0015105, filed Feb. 24, 2009, which is hereby incorporated by reference in its entirety as if fully set forth herein.

### BACKGROUND OF THE DISCLOSURE

1. Field of the Disclosure

The present invention relates to a controlling method of a dishwasher, more particularly, to a controlling method of a dishwasher that allows for an enhanced washing efficiency and a reduction in washing time.

2. Discussion of the Related Art

In general, dishwashers are home appliances that are used to wash dishes such as cups, plates, bowls, and the like. Dishwashers receive dishes and wash the dishes by using wash water supplied thereto.

However, such a dishwasher may have a disadvantage of deteriorated washing efficiency or long washing time.

### SUMMARY OF THE DISCLOSURE

Accordingly, the present invention is directed to dishwasher.

At least one advantage and feature of the present invention is to provide a controlling method of a dishwasher able to improve washing efficiency.

At least another advantage and feature of the present invention is to provide a controlling method of a dishwasher able to reduce washing time.

Additional advantages and features of the invention will be set forth in part in the description which follows and in part will become apparent to those having ordinary skill in the art upon examination of the following or may be learned from practice of the invention. The advantages and features of the invention may be realized and attained by the structure particularly pointed out in the written description and claims hereof as well as the appended drawings.

To achieve these advantages and features, and in accordance with the purpose of the invention, as embodied and broadly described herein, a controlling method of a dishwasher including a wash water supplying step and a steam supplying step may comprise a washing step having the wash water supplying step and the steam supplying step, wherein, for a predetermined amount of time, the wash water supplying step is simultaneously performed with the steam supplying step.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure.

FIG. 1 is a perspective view illustrating a dishwasher according to an exemplary embodiment of the present invention.

FIG. 2 is a longitudinal-sectional view of the dishwasher of FIG. 1.

FIG. 3 is a flow chart illustrating a controlling method of a dishwasher according to an exemplary embodiment of the present invention.

FIG. 4 is a graph illustrating an embodiment of a washing step having a steam supplying step and a wash water supplying step that are overlapped for a predetermined period of time according to an embodiment of the invention.

FIG. 5 is a graph illustrating a washing step having a steam supplying step and a wash water supplying step that are overlapped in at least a predetermined period, all according to another exemplary embodiment of the present invention.

FIG. 6 is a graph illustrating a washing step having a steam supplying step and a wash water supplying step that are overlapped in at least a predetermined period, all according to yet another exemplary embodiment of the present invention.

FIG. 7 is a graph illustrating a washing step having a steam supplying step and a wash water supplying step that are overlapped in at least a predetermined period, all according to still another exemplary embodiment of the present invention.

FIG. 8 is a flow chart illustrating a non-detergent course according to a controlling method of a dishwasher according to an exemplary embodiment of the present invention.

FIG. 9 is a flow chart illustrating a detergent course according to a controlling method of a dishwasher according to another exemplary embodiment of the present invention.

FIG. 10 is a graph illustrating temperature change in washing objects according to the controlling method of FIG. 8.

### DESCRIPTION OF SPECIFIC. EMBODIMENTS

Reference will now be made in detail to the specific embodiments of the present invention, examples of which are illustrated in the accompanying drawings. Wherever possible, the same reference numbers will be used throughout the drawings to refer to the same or like parts.

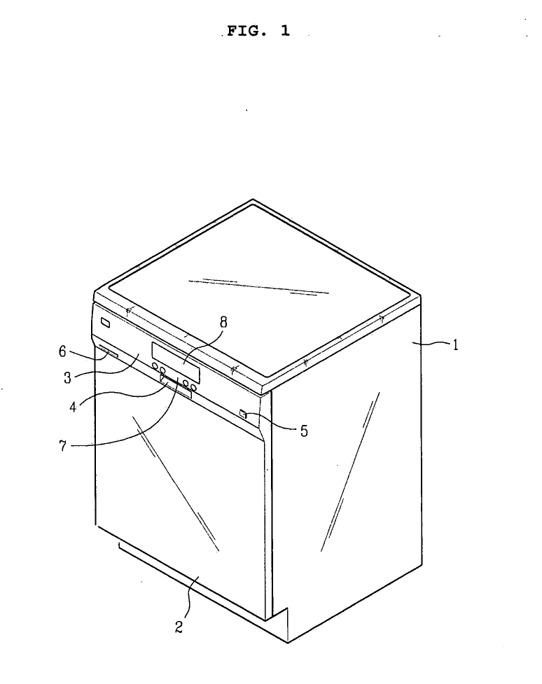

FIG. 1 is a perspective view illustrating a dishwasher according to an exemplary embodiment of the present invention.

In reference to FIG. 1, a dishwasher includes a cabinet 1, a door 2, and a control panel 3. The cabinet 1 has an open front and the door 2 opens and closes the open front of the cabinet 1. The control panel 3 is provided in an upper portion of the door 2 to display and control an overall operation of the dishwasher.

The cabinet 1 defines an exterior appearance of the dishwasher and includes various components that will be described later. The door 2 is coupled to the front of the cabinet 1 and a user opens the door to gain access to the cabinet, for example, to put washing objects into, or to take washing objects out of, the dishwasher.

The control panel 3 includes a power switch 5 for powering on and off the dishwasher, an operation selection part 7 for a user to select operation courses of the dishwasher and a display part 8 for displaying an operational state of the dishwasher.

A door handle 4 may be provided in the front of the cabinet 1. The door handle 4 may be used to open and close the door 2. An outlet 6 may be further provided in the front of the cabinet 1 and hot air inside the dishwasher may be discharged from the dishwasher via the outlet 6.

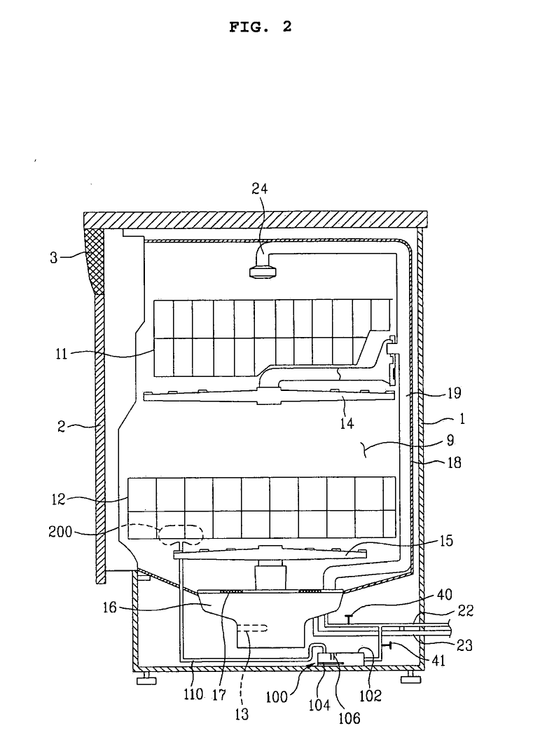

FIG. 2 is a longitudinal-sectional view of the dishwasher of FIG. 1.

In reference to FIG. 2, the dishwasher includes a tub 18 and a sump 16. The tub 18 is provided in the cabinet 1 and it forms an accommodation space 9 where washing objects, such as dishes, are washed. The sump 16 is provided underneath the tub 18 to supply wash water to the accommodation space 9 in the tub 18 and to re-supply wash water to the accommodation space 9 after food substances contained in the wash water are filtered therefrom.

A pump (not shown), such as an impeller to pump the wash water, may be provided in the sump 16. It is preferable that the sump 16 includes a first heater 13 configured to heat the wash water received in the sump 16. The wash water heated by the first heater 13 may be injected toward washing objects in the accommodation space 9 in the tub 18. As a result, detergent product (which improves washing efficiency) dissolved in the heated wash water (which also improves washing efficiency) may come into contact with food scraps or other contaminants remaining on the washing objects, thoroughly soaking the same. The heated wash water containing detergent sprayed onto the washing objects removes the food scraps or other contaminants from the washing objects.

In the accommodation space 9 formed in the tub 18 a plurality of racks 11, 12 and a plurality of spraying arms 14, 15, 24 may be provided. The racks 11 and 12 in the exemplary embodiment are separated into upper and lower racks, respectively. The spraying arms 14, 15, 24 spray wash water toward each of the racks 11, 12. In addition, a filter 17 may be provided in a lower portion of the tub 18 and food scraps contained in the wash water may be filtered therefrom as wash water passes through the filter 17. A wash water path 19 may be provided in a predetermined portion of the tub 18 to supply the wash water to an uppermost spraying arm 24 and an upper spraying arm 14. Although not shown in the drawings, the wash water path may be configured as two paths corresponding to the uppermost spraying arm and the upper spraying arm, respectively.

Furthermore, the dishwasher may include a steam generating device 100, a steam path 110, and at least one nozzle combination 200. The steam generating device 100 generates steam supplied to the accommodation space 9 in the tub 18. The steam generated by the steam generating device 100 passes through the steam path 110 into the tub 18. The steam passing through the steam path 110 is supplied to the tub 18 via the at least one nozzle combination 200.

If the steam generated by the steam generating device 100 is supplied to the accommodation space 9, dirt such as food scraps attached to surfaces of the washing objects may be soaked more thoroughly by the steam, and washing efficiency may be improved accordingly.

According to the dishwasher of the present invention, the position of the steam generating device 100 is not limited to any specific place mentioned above. However, it is preferable that the steam generating device 100 is provided under the tub 18. As a result, the steam generated by the steam generating device 100 may be supplied to the tub 18 efficiently, because generally the steam has a property of ascending upward with its high temperature. Although not shown in the drawings, the steam generating device 100 may be provided on a side of the tub 18.

The steam generating device 100 is now described in greater detail. The steam generating device 100 may include a housing 102, a second heater 104, a water level sensor 106, and an overheating prevention means (not shown). The housing 102 receives water and the second heater 104 heats the water received in the housing 102. The water level sensor 106 measures water levels of the water in the housing 102. The overheating prevention means prevents the second heater 104 from overheating.

If it is necessary to supply steam to the washing objects, water is supplied to the housing 102. The water level sensor 106 indicates the level of water within the housing 102, and therefore, it can be determined whether an appropriate amount of water is supplied. The water in the housing 102 is heated by the second heater 104 to generate steam. The generated steam is supplied to the tub 18 via the steam path 110 and the nozzle combination 200.

The dishwasher may further include a water supply line 22, a water drain line 23, a first water supply valve 40, and a second water supply valve 41. The first water supply valve 40 may control the supply of water to the sump 16. The second water supply valve 41 may control the supply of water to the steam generating device 100. The water supply line 22 may be branched to supply water to both of the sump 16 and the steam generating device 100 from an external water source. The contaminated water used in washing the washing objects may be drained via the water drain line 23. The water supply valve 40 opens or closes the path to the water supply line 22 to control the amount of water supplied to the sump 16. The second water supply valve 41 opens or closes the path to the steam generating device 100 to control the amount of water supplied to the steam generating device 100. In the exemplary embodiment, the water supply valve 40 controls the amount of water supplied to the sump 16 and the second water supply valve 41 controls the amount of water supplied to the steam generating device 100.

Water in the housing 102 is heated by the second heater 104 to generate steam, which is sprayed toward the washing objects in the dishwasher having the above configuration. Wash water in the sump 16 is heated by the first heater 13 to provide heated wash water, which is sprayed toward the washing objects in the dishwasher having the above configuration. A predetermined period of time is required for a process of changing heated water in the housing 102 into steam. Also, a predetermined period of time is required for a process of heating wash water in the sump 16 to a predetermined temperature.

When the first heater 13 provided in the sump and the second heater 104 provided in the steam generating device 100 are operated separately, without any overlap of the operation of the first and second heaters, the overall operation time of the dishwasher is inconveniently increased, at least by the time taken to heat water and to generate steam.

As an example, in the case of washing a washing object such as a cup with a relatively low pollution level, which does not present much of a washing load but requires frequent washings, a long or increased washing time is very inconvenient to the user. Consequently, Because of that, at least in the case of the washing objects presenting a relatively low washing load but requiring frequent washings, it is desirable to reduce the washing time.

Moreover, in the case where the steam and the heated wash water are supplied alternately, for example when switching between the spraying of steam and the spraying of heated wash water toward the washing objects in the accommodation space 9 in the tub, the temperature of the washing objects in the accommodation space 9 in the tub 18 may increase gradually. That is, if the steam is sprayed into the tub, the temperature of the washing objects may increase. After the heated wash water is sprayed, the temperature of the washing objects may be maintained at a predetermined value. This is because the temperature of the heated wash water, even after heating, is lower than the temperature of the steam. If the temperature of the washing objects increases gradually, removal of the contaminants attached to the washing objects in the accommodation space 9 in the tub is made difficult, which therefore decreases washing efficiency.

However, when implementing the controlling method of a dishwasher as disclosed herein, washing efficiency increases.

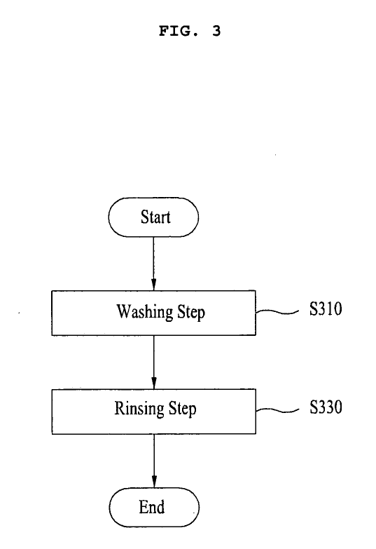

FIG. 3 is a flow chart illustrating a controlling method of a dishwasher according to an exemplary embodiment of the present invention. The controlling method of the dishwasher may be included in courses of the dishwasher, such as washing or rinsing, or it may form a separate course selectable from the operation selection part 7 (FIG. 1), such as a ‘cup washing course’ or a ‘small washing course’.

With reference to FIG. 3, the controlling method of the dishwasher according to this embodiment includes a washing step (S310), which includes simultaneously supplying steam and wash water to washing objects for a predetermined time period and a rinsing step (S330) including rinsing the washing objects.

The washing step according to this embodiment includes a wash water supplying step and a steam supplying step.

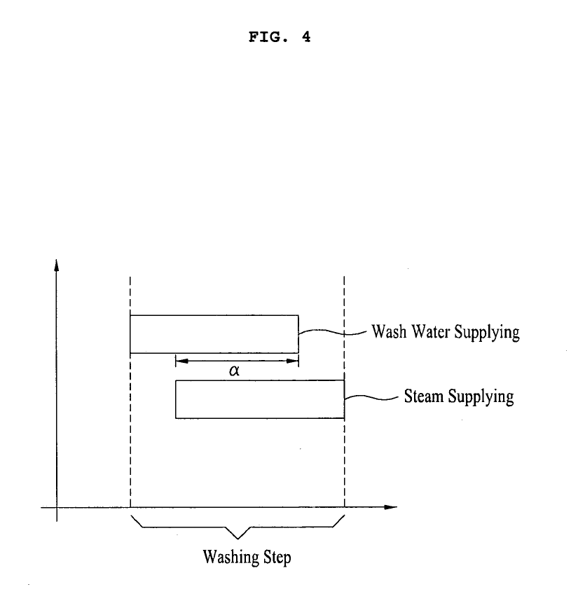

FIG. 4 is a graph illustrating an embodiment of a washing step having a steam supplying step and a wash water supplying step that are overlapped for a predetermined period of time according to an embodiment of the invention.

With reference to FIG. 4, the wash water supplying step and the steam supplying step are performed simultaneously for at least a predetermined time period (α), during which the wash water supplying step and the steam supplying step are overlapped in time. As a result, the steam and the wash water may be simultaneously supplied to the washing objects for at least the predetermined time period (α). In this case, it is preferable that heated wash water is supplied in the wash water supplying step, to improve washing efficiency, which will be described as follows.

Once a user powers on the dishwasher, a control part, such as a controller, supplies water to both the sump 16 and the steam generating device 100. Then, the control part operates the first heater 13 of the sump 16 and the second heater 104 of the steam generating device 100. Because of this, the wash water in the sump 16 is heated and steam is generated in the steam generating device 100. Hence, the control part starts the washing step.

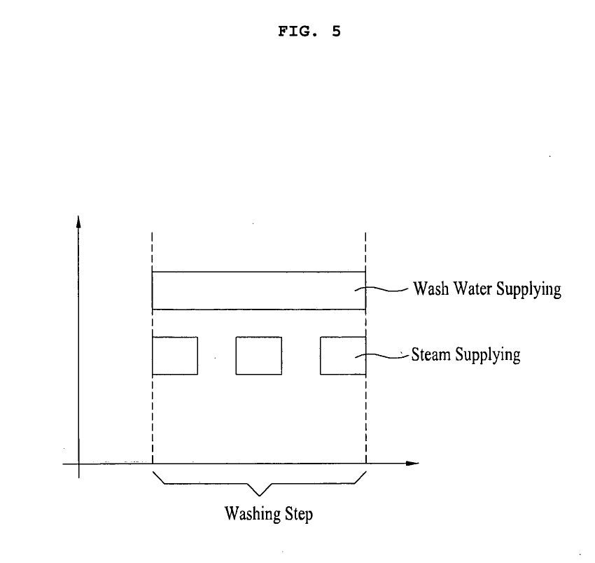

The process of supplying steam and heated wash water simultaneously may be embodied variously. Examples of various embodiments are presented in FIGS. 5 to 7.

FIG. 5 is a graph illustrating a washing step having a steam supplying step and a wash water supplying step that are overlapped in at least a predetermined period, all according to another exemplary embodiment of the present invention. With reference to FIG. 5, the control part causes the execution of the steam supplying step at least one time during the wash water supplying step in a washing step.

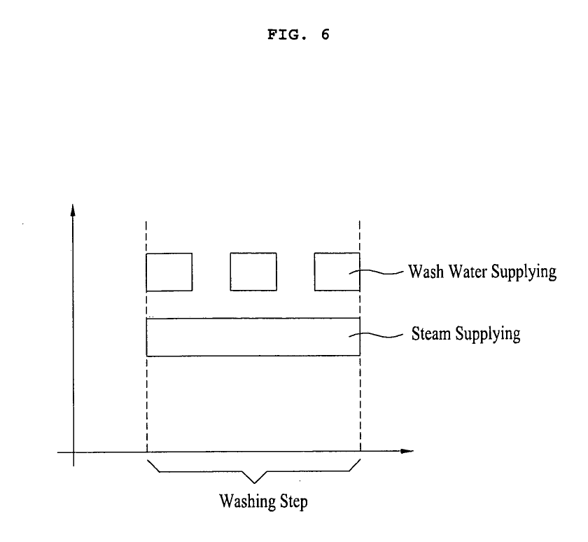

FIG. 6 is a graph illustrating a washing step having a steam supplying step and a wash water supplying step that are overlapped in at least a predetermined period, all according to yet another exemplary embodiment of the present invention. With reference to FIG. 6, the control part causes the execution of the washing water supplying step at least one time during the steam supplying step in a washing step.

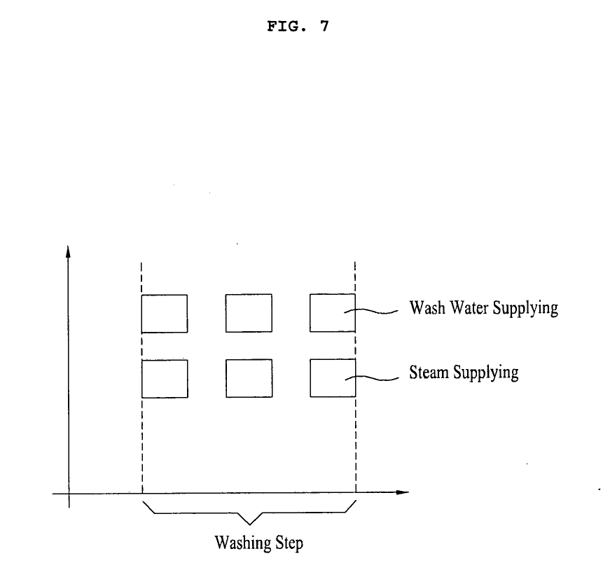

FIG. 7 is a graph illustrating a washing step having a steam supplying step and a wash water supplying step that are overlapped in at least a predetermined period, all according to still another exemplary embodiment of the present invention. With reference to FIG. 7, the control part causes the execution of both the steam supplying step and the washing water supplying step at least one time in a washing step.

If at least some sections of both the steam supplying step and the wash water supplying step are overlapped in the washing step, the steam and the heated wash water may be sprayed toward the washing objects in the accommodation space 9 in the tub 18 at the same time.

If both the steam and the heated wash water supplying steps are performed simultaneously, at least over a common period of time, the washing efficiency of the dishwasher increases, and the overall length of time required to complete a washing step is reduced.

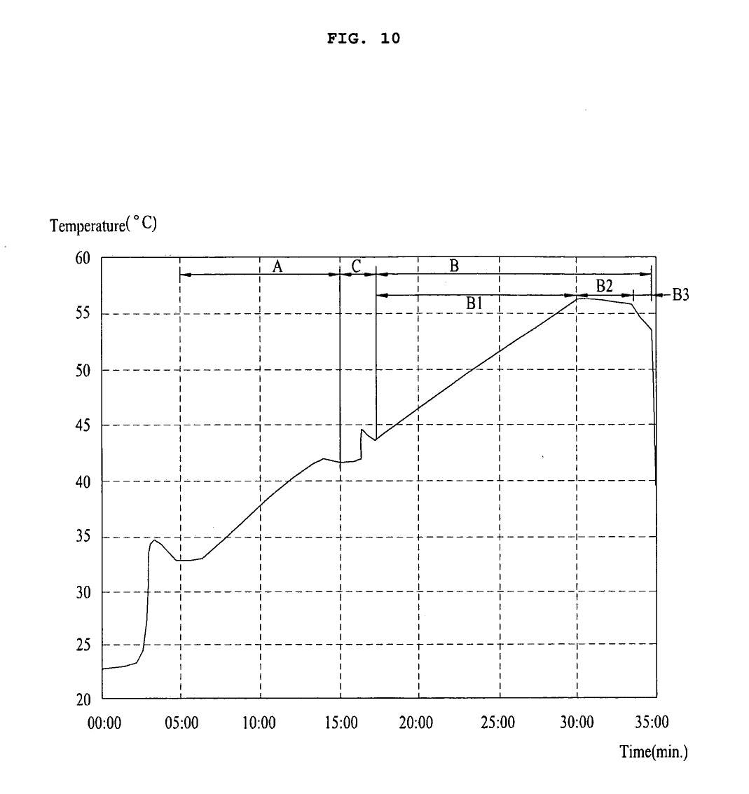

In addition, if the steam and the heated wash water are supplied simultaneously, the temperature of the washing objects within the tub 18 may be increased over time, as previously described, and as illustrated, for example, in FIG. 10.

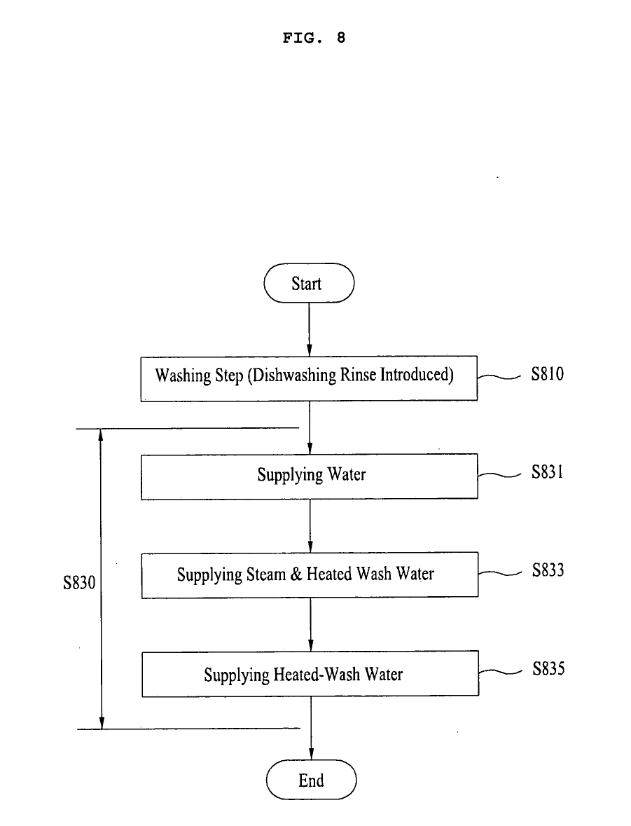

FIG. 10 is a graph illustrating temperature change in washing objects in the accommodation space 9 in the tub 18, according to an exemplary embodiment of the present invention, which is itself illustrated in the flow diagram of FIG. 8.

With reference to FIG. 10, ‘A’ section corresponds to the washing step, ‘B’ section corresponds to the rinsing step, and ‘C’ section corresponds to an intermediate step between the washing and rinsing steps, for example, a draining step. Both the steam and the heated wash water are simultaneously supplied during the overall section of the washing step ‘A’ shown in FIG. 10. As will be understood, the method of FIG. 8, and the time versus temperature graph illustrated in FIG. 10, represent only one possible embodiment according to the present invention; the present invention is not limited by the embodiment of FIG. 8 or the illustration of FIG. 10.

As shown in FIG. 10, both the steam and the wash water are simultaneously supplied to the accommodation space in the tub 18 during the washing step according to this embodiment. As a result, the temperature of the washing objects in the accommodation space 9 in the tub 18 increases with a roughly uniform slope over time. The slope may be predetermined. Thus, it is possible to soak and remove contaminants, such as food scraps, attached to the washing objects in the accommodation space 9 in the tub 18 efficiently. The ‘B’ and ‘C’ sections mentioned above will be described later.

In case of supplying the heated wash water, this washing step may include a step of supplying the heated wash water from the upper and lower portions of the accommodation space 9 alternately at a predetermined interval.

Specifically, the heated wash water is sprayed from the upper portion of the accommodation space 9 via the uppermost spraying arm 24 and the upper spraying arm 14 of the spraying arms provided in the tub 18. The heated wash water is supplied from the lower portion of the accommodation space 9 via the lower spraying arm 15. As a result, the heated wash water may be sprayed from the upper and lower portions of the accommodation space 9 alternately at a predetermined interval.

For example, if the time of the washing step is ten minutes, the time of the step alternately supplying the wash water may include steps of supplying the wash water from the upper portion of the accommodation space 9 is one minute, specifically, from the lower portion for one minute, from the upper portion for one minute, from the lower portion for one minute and from the upper portion for 6 minutes. In this case, the steam is continuously sprayed upward from the lower portion of the tub 18 via the nozzle combination 200 provided in the lower portion of the tub 18.

The controlling method according to this embodiment may be applicable to washing objects such as cups, which present a small washing load and require often washings. Because the washing objects such as cups are washed often, and because cups typically have a low pollution level, a non-detergent course may be used. In this case, if performing a rinsing step, a dishwashing rinse aide product may be supplied. FIG. 8 is a flow chart illustrating a non-detergent course according to a controlling method of a dishwasher according to an exemplary embodiment of the present invention.

With reference to FIG. 8, according to the exemplary controlling method for the non-detergent course, the control part of the dishwasher supplies dishwashing rinse aide product to the accommodation space 9 in a predetermined time period after the above washing step starts (S810).

That is, the control part may not supply the dishwashing rinse aide product to the washing objects when the rinsing step starts. The control part may introduce the dishwashing rinse aide product to the washing objects at a predetermined time such as, for example, five minutes after the washing step begins. If dishwashing rinse aide product is introduced during the washing step, the dishwashing rinse aide product may attach to surfaces of the washing objects with the help of the steam and the heated wash water supplied during the washing step. Accordingly, rinsing efficiency of the rinsing step may be improved.

After the washing step mentioned above, the controlling method according to this embodiment may further include a water draining step (C) to drain the wash water from the tub 18 to, for example, a drain outside of the dishwasher. With reference to FIG. 10, the wash water is drained during the ‘C’ section, corresponding to the water draining step, such that the temperature of washing objects in the accommodation space 9 in the tub 18 may not increase because the heated wash water and the steam are not supplied.

With reference to FIG. 8 again, the rinsing step (S830) is performed after the water draining step (C) of FIG. 10. The rinsing step may include steps of supplying wash water to the dishwasher (S831), simultaneously supplying steam and heated water to the washing objects for a predetermined time period (S833), and supplying only the heated wash water to the washing objects (S835).

During the rinsing step, the wash water is supplied to the dishwasher to rinse the washing objects (S831). In this case, wash water is supplied to the sump 16 and then sprayed toward the washing objects via the spraying arms 14, 15, and 24. When supplying wash water, the wash water may be sprayed via all spraying arms 14, 15, and 24 or it may be sprayed toward the upper and lower portions of the accommodation space 9 alternately as mentioned above.

The first heater 13 of the sump 16 and the second heater 104 of the steam generating device 100 are operated to simultaneously supply both steam and heated wash water to the washing objects for a predetermined time period (S833).

As mentioned above, the controlling method according to this embodiment may be performed in a ‘non-detergent course’ (where no detergent product is introduced into the accommodation space 9) used to wash the washing objects. If so, the rinsing step may be performed even though the contaminants may not have been removed completely during the washing step. According to the controlling method of this embodiment, to rinse and remove the contaminants that were not completely removed from the washing objects, a step of supplying the heated wash water and the steam during an initial period of the rinsing step may be provided.

The step of supplying steam and heated wash water simultaneously during the rinsing step is similar to the washing step mentioned above.

That is, in the simultaneously supplying step, steam supplying is performed at least once during the heated wash water supplying step or the heated wash water supply is performed at least once during the steam supplying step. Moreover, the heated wash water supplying and the steam supplying are performed simultaneously at least once in the simultaneously supplying step.

Here, the operation time of the step of simultaneously supplying the steam and the wash water included in the rinsing step may be substantially shorter than that of the washing step. For example, if the washing step is preset to operate for 10 minutes, the step of simultaneously supplying the steam and the heated wash water may be preset to operate for 7 minutes.

After the steam and the heated wash water are sprayed toward the washing objects simultaneously, the second heater 104 of the steam generating device 100 is turned off and only the first heater 13 of the sump 16 is operated to continue to heat water that is sprayed toward the washing objects (S835).

If the steam and the heated wash water are supplied simultaneously to the washing objects, a primary rinse for the washing objects may be performed. Additionally a secondary rinse, including heated water without steam, may also be performed. During the secondary rinse, where the steam is not supplied, the electricity consumed by the dishwasher may be reduced. In addition, the step of supplying only the heated water may be performed approximately for 6 minutes, for example.

After the step of simultaneously supplying the steam and the heated wash water and the step of supplying only the heated wash water are performed in the rinsing step, the temperature of the washing objects in the accommodation space 9 in the tub 18 may increase. If the user touches the washing objects at this time, there could be a danger of getting burned.

Because of that, the rinsing step may further include a step of supplying only wash water to the accommodation space 9 in the tub 18, after turning off the first heater 13 of the sump 16 and the second heater 104 of the steam generating device 100. That is, wash water that is not heated may be sprayed toward the washing objects to decrease the temperature of the washing objects. The step of supplying unheated wash water may be performed for approximately 2 minutes, for example.

With reference to FIG. 10, the ‘B’ section corresponding to the rinsing step is classified into a ‘B1’ section (where steam and heated wash water are provided simultaneously), a ‘B2’ section (where only heated wash water is provided), and a ‘B3’ section (where only unheated wash water is provided).

Because both steam and heated wash water are provided simultaneously to the washing objects during the ‘B1’ section, the temperature of the washing objects in the accommodation space 9 in the tub 18 may increase continuously, according to roughly constant slope. Consequently, contaminants that were not removed during the washing step may be removed during primary rinsing.

Because only heated wash water is supplied, without steam, in the ‘B2’ section, the temperature of the washing objects in the accommodation space 9 in the tub 18 may not increase. Consequently, the temperature of the washing objects in the accommodation space 9 in the tub 18 may be maintained at a predetermined temperature value. During the ‘B2’ section, secondary rinsing is performed using only heated wash water as mentioned above.

Lastly, because only unheated wash water is supplied during the ‘B3’ section, the temperature of the washing objects in the accommodation space 9 in the tub 18 may decrease, thereby cooling the washing objects.

The controlling method according to this embodiment corresponds to the ‘non-detergent course’; however, a controlling method according to another embodiment may be performed to correspond to a ‘detergent course’, where detergent product is introduced into the accommodation space 9.

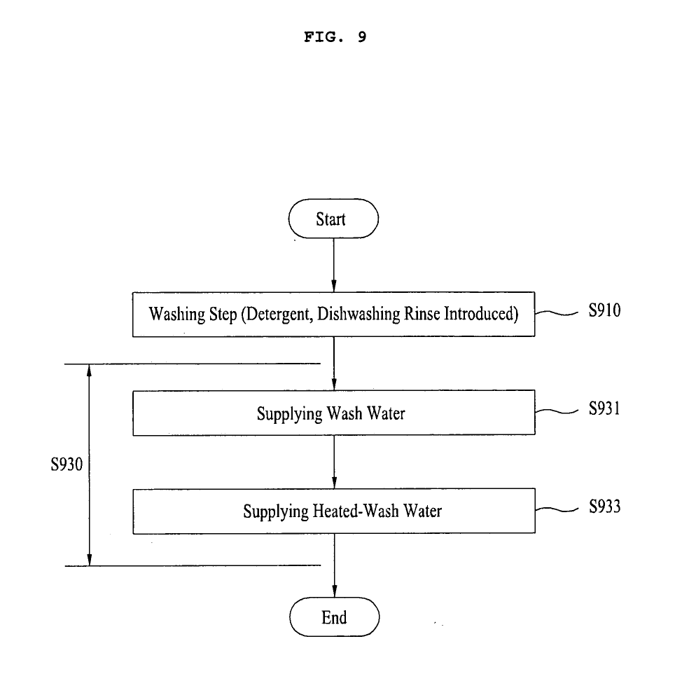

Compared to the above embodiment, the controlling method performed in the detergent course may include a step of supplying detergent product during the washing step. Additionally, the step of simultaneously supplying steam and heated wash water may not be performed during the rinsing step. FIG. 9 is a flow chart illustrating a detergent course according to a controlling method of a dishwasher according to another exemplary embodiment of the present invention.

With reference to FIG. 9, the controlling method performed in the detergent course includes a washing step and a rinsing step as in the above described embodiments. In the washing step, detergent product and dishwashing rinse aide product are introduced at predetermined times (S910).

That is, by way of example, when a washing step is performed, detergent product is introduced into the tub 18 simultaneously with the beginning of the performance of the washing step. The other configuration of this embodiment is similar to the configuration of the above embodiment except that the dishwashing rinse aide product is supplied after the detergent product is supplied.

The rinsing step (S930), according to the controlling method of this embodiment, includes a wash water supplying step that supplies wash water to the dishwasher (S931) and a heated wash water supplying step that heats the wash water, thereby supplying heated wash water to the washing objects. In addition, the controlling method may further include an unheated wash water supplying step that supplies unheated wash water to the washing objects.

According to the controlling method of this embodiment, when performing the rinsing step, the step of simultaneously supplying steam and heated wash water is not performed and this is different from the above embodiment. Because detergent product is introduced in the washing step according to this embodiment, there would be little probability contaminants remain on the washing objects after the washing step. As a result, the step of simultaneously supplying steam and heated wash water is not performed in the rinsing step and thus less electricity may be consumed by the dishwasher.

The time taken to operate each of the steps described in the controlling method according to this embodiment may be different from the time taken according to the previous embodiment.

For example, the washing step according to this embodiment may be preset to operate approximately for seventeen minutes. Then, the step of supplying steam and heated wash water may alternately be preset to perform from the upper portion of the accommodation space 9 for one minute, specifically, from the lower portion of the accommodation space 9 for one minute, from the upper portion for one minute, from the lower portion for one minute and from the upper portion for thirteen minutes. Also, in the step of supplying the heated wash water included in the rinsing step according to this embodiment, the first heater 13 may be operated approximately for six minutes, for example, and the unheated wash water may be supplied for approximately two minutes, for example.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A controlling method of a dishwasher, comprising:
a washing step comprising a wash water supplying step and a steam supplying step, wherein, for a predetermined amount of time, the wash water supplying step is simultaneously performed with the steam supplying step.

2. The controlling method of claim 1, wherein heated wash water is supplied during the wash water supplying step.

3. The controlling method of claim 2, wherein the steam supplying step is performed at least once during the wash water supplying step in the washing step.

4. The controlling method of claim 2, wherein the wash water supplying step is performed at least once during the steam supplying step in the washing step.

5. The controlling method of claim 2, wherein the wash water supplying step and the steam supplying step are simultaneously performed at least once during the washing step.

6. The controlling method of claim 2, wherein the heated wash water is alternately sprayed to an upper portion and a lower portion of an accommodation space within the dishwasher.

7. The controlling method of claim 2, further comprising:
a rinsing step performed after the washing step.

8. The controlling method of claim 7, wherein a dishwashing rinse aide product is introduced at a predetermined time after a start of the washing step.

9. The controlling method of claim 8, wherein the dishwashing rinse aide product is introduced before the rinsing step starts.

10. The controlling method of claim 7, further comprising:
a draining step to drain the wash water between the washing step and the rinsing step.

11. The controlling method of claim 7, wherein the rinsing step comprises:
a wash water supplying step to supply wash water to the dishwasher;
a simultaneous-supplying step to simultaneously supply steam and heated wash water to the accommodation space of the dishwasher for a predetermined period of time; and
a heated wash water supplying step to supply heated wash water, without supplying steam, to the accommodation space of the dishwasher.

12. The controlling method of claim 11, wherein the steam supplying is performed at least once during the wash water supplying in the simultaneous-supplying step.

13. The controlling method of claim 11, wherein the wash water supplying is performed at least once during the steam supplying in the simultaneous-supplying step.

14. The controlling method of claim 11, wherein the wash water supplying and the steam supplying are simultaneously performed at least once during the simultaneous-supplying step.

15. The controlling method of claim 11, further comprising:
an unheated wash water supplying step to supply wash water that is not heated to the accommodation space of the dishwasher.

16. The controlling method of claim 7, wherein dishwashing rinse aide product is introduced at a predetermined time after detergent product is introduced in the washing step.

17. The controlling method of claim 16, wherein the dishwashing rinse aide product is introduced before the rinsing step starts.

18. The controlling method of claim 16, further comprising:
a draining step to drain the wash water after the washing step.

19. The controlling method of claim 18, wherein the rinsing step comprises:
a wash water supplying step to supply wash water to the dishwasher; and
a heated wash water supplying step to supply heated wash water to the accommodation space of the dishwasher.

20. The controlling method of claim 19, further comprising:
an unheated wash water supplying step to supply unheated wash water to the accommodation space of the dishwasher.
